(19) United States
(12) Patent Application Publication
(10) Pub. No.: US 2002/0031598 A1
(43) Pub. Date: Mar. 14, 2002

(54) Method of conditioning fruits for subsequent drying for production of an instant product

(76) Inventors: Manfred Lukas, Trebur (DE); Horst Kriszio, Offenbach (DE); Lukasz Wandzilak, Kronberg (DE); Jurgen Wittekind, Frankfurt am Main (DE); Horst Schmittberger, Darmstadt (DE); Steffen Schumann, Ingelheim (DE)

Correspondence Address: QUARLES & BRADY LLP, 411 E. WISCONSIN AVENUE, SUITE 2040, MILWAUKEE, WI, 53202-4497, US

(21) Appl. No.: 09/906,483

(22) Filed: Jul. 16, 2001

(30) Foreign Application Priority Data
Jul. 19, 2000 (EP) 00 115 567.0

(51) Int. Cl. A23L 1/06

(52) U.S. Cl. 426/640; 426/615; 426/639

(57) ABSTRACT

A method of conditioning fruits for subsequent drying for the production of an instant product, with a conditioning solution system used in the method comprising multiple conditioning agents which are permissible under the laws relating to food and drugs, the fruits, as whole and cut fruits in a fresh or frozen condition, being subjected in one or more sequential process steps to a conditioning with calcium ions, pectin esterase, and an oil-in-water emulsion to which an emulsifier in a proportion of more than 1% by weight is added.

### FIELD OF INVENTION

The invention concerns a method of conditioning fruits for subsequent drying for production of an instant product. A conditioning solution system used in the method comprises multiple conditioning agents which are permissible under the laws relating to food and drugs. The fruits can hereby be both whole and cut fruits in a fresh or frozen condition, or possibly also a slightly dried condition, which are conditioned with or without their peels and then dried.

### BACKGROUND OF THE INVENTION

Drying fruit is a very old technique for preserving fruit. However, from the viewpoint of industrial food processing, only drying processes in which large amounts of fruits can be dried in a short time using elevated temperatures in appropriate drying facilities are to be considered as relevant.

With these types of drying processes, it is possible to dry large harvests at certain seasons before the fruits spoil. In order to, for example, manage the peaks of harvests and to profitably use the drying facilities present, it is, however, necessary to temporarily preserve the fruit by means of deep freezing. However, due to the cell wall damage which occurs during freezing, the subsequent drying can be made extraordinarily difficult.

Depending on the species, variety, and degree of ripeness of the fruit, fruits tend to stick together while being dried at an elevated air temperature, which, under certain circumstances, makes careful drying impossible and which is very unfavorable when using the dried fruits in instant products, because the surfaces of the fruit which are stuck together reabsorb water only slowly.

The fruits stick together due to both the fruit sugar and the pectin in the fruits. The fruits stick together particularly strongly when fruit juice is released due to cutting or after the thawing of frozen fruits. This is particularly problematic for subsequent drying of fruits such as strawberries.

A long-known measure from the food industry against sticking together in general is the use of baking releasing oils. Furthermore, medium chain triglycerides with a mixture of natural wax esters soluble in the triglyceride are known from DE 30 07 469 A1 as a releasing or separating oil. This releasing oil is applied to, among other things, dried fruits and fruit jelly articles and forms a thin oil film, which prevents sticking together, on the surface of the fruits, etc.. However, this oil film is detrimental for rehydration, which is significant for instant products. Furthermore, under some circumstances the fruits obtain a high fat content, which is not typical for fruits. One can attempt to reduce the disadvantages mentioned through the use of an aqueous oil emulsion, but they cannot be fully avoided.

If an oil-in-water emulsion is used, a further disadvantage results in that the emulsion unavoidably absorbs fruit juice, which then, on one hand, is lacking in the fruit as an important flavor component and, on the other hand, dilutes the oil emulsion. Due to this juice absorption, a large volume of fluid must be disposed of, which must be freed from oil before being discharged into the wastewater until it conforms to the respective discharge regulations, a costly process.

Independent from the application of releasing oils to dried fruit pieces and similar items, the application of calcium ions for the treatment of fruits, e.g. in order to increase their firmness and consistency before a sterilization treatment, is also long known, and also in combination with deesterifying enzymes in the form of pectin esterase (U.S. Pat. No. 2,534,263). In EP 0123 345, an improvement of the consistency of fruits due to gelation through the use of pectin enzymes is indicated.

For obtaining instant dried fruits with good rehydration properties, however, neither an increase of firmness, which interferes with water absorption, nor gelation, which increases the effect of sticking together, are desirable.

### BRIEF SUMMARY OF THE INVENTION

The present invention provides a method for conditioning fruits for subsequent drying for production of an instant product. The method includes subjecting the fruits to a conditioning solution including calcium ions, pectin esterase, and an oil-in-water emulsion, to which oil-in-water-emulsion an emulsifier is added in an amount of more than 1% by weight.

It is an object of the invention to provide a method of conditioning fruits for subsequent drying for production of an instant product, whereby the fruits and/or fruit pieces can be conditioned in such a way that they can be successfully dried and, after having been dried, still show good rehydration behavior. This object is achieved by the subject matter of the independent claims. Preferred further developments are defined in the sub-claims.

### BRIEF DESCRIPTION OF THE DRAWINGS

FIG. 1 is a schematic drawing of a conditioning system incorporating the present invention; and

FIG. 2 is a schematic drawing of an alternative conditioning system modified relative to the system of FIG. 1.

### DETAILED DESCRIPTION OF THE PREFERRED EMBODIMENTS

Fruit is conditioned for subsequent drying by subjecting the fruit to a conditioning solution as disclosed herein. The solution used according to the invention consists in using both calcium ions and pectin esterase as the conditioning agent, as well as an oil-in-water emulsion with an emulsifier which is used in an amount being increased in comparison to typical emulsions of the food industry, to values of more than 1% by weight of the emulsion mass. In this special combination, the agents known per se were successfully used to prevent sticking together of the fruits and fruit pieces in a subsequent drying process and, in addition, to produce well rehydratable instant products of the respective fruit.

Advantageously, the inventors have succeeded in using the separating or releasing agents mentioned above, known per se, for preparing the desired instant products in spite of the various problems discussed above. This was particularly surprising because the initial experiments of the inventors with the addition of calcium ions and pectin esterase were anything but encouraging and, for example, in the use of typical baking releasing oils and their emulsions on strawberry pieces, only oily masses of fruit were obtained, which were completely unsuitable for subsequent drying.

Although the agents mentioned above can be used in one single combined conditioning solution in the form of an oil-in-water emulsion with the other additives mentioned, especially the fruits which contain or release a large amount of fruit juice are preferably subjected to a multi-step conditioning before drying, in which first the release of juice is significantly reduced by the use of calcium ions. Thereby, in a subsequent conditioning step, a suitable aqueous separating or releasing oil emulsion can be applied without being significantly diluted by the fruit juice and so that the fruits do not absorb significant amounts of oil. The application of pectin esterase can be performed after or simultaneously with that of the calcium ions, whereby the pectin esterase can be added to the calcium ion bath, a separate bath, or also the emulsion bath.

The fruits or fruit pieces in fresh and frozen condition are preferably first placed in a heated, aqueous solution containing calcium ions. Of the different possible calcium solutions, such as calcium citrate, tested up to this point, the calcium chloride solution has proved its worth the most, for which reason it is preferred. Calcium malate represents another alternative. The temperature of the solution is adjusted so that, after the fruit is fed in, a temperature optimal for the effectiveness of the subsequent enzyme conditioning automatically results. The optimum temperature generally lies around 35° C. and can, if desired, also be reduced.

The fruits are, after a sufficient reaction time, removed from this calcium ion solution, with the fine particles of fruit which increase sticking together simultaneously filtered off, and are then transferred into a pectin esterase solution for demethoxylation of the pectin.

In the way described, the fruits can be heated to an optimum temperature for the enzyme effectiveness of the pectin esterase in a short time and thereby in a careful way, because the temperature of the calcium ion solution can be adjusted sufficiently high and even heating above the critical temperature (approximately 45° C.) for pectin esterase is possible, since pectin esterase has not yet been added to the calcium ion containing solution. This is particularly advantageous if frozen fruits are to be thawed and dried. After the subsequent pectin esterase conditioning, the fruits are fed into the oil-in-water emulsion. The pectin esterase can also be added to this emulsion bath if a separate pectin esterase bath is to be avoided. The drying step following the emulsion conditioning can be performed in a known way in an air belt dryer and/or in typical single stage or multistage drying facilities. An example of a drying facility with microwave drying can be seen in DE 196 43 989 A1. Special vacuum dryers and freeze dryers are also possible.

The advantage of performing the releasing oil emulsion conditioning separately from the calcium ion and pectin esterase conditioning is that the amounts of fruit juice which are released from the fruits concentrate only in the calcium ion and/or calcium ion/pectin esterase solution and can be disposed with these solutions, without problems, if desired. The volume of the releasing oil emulsion, which requires oil separation before being discharged into the wastewater, remains, in contrast, is practically unchanged.

It has been further determined in experiments that, by means of adding sugar, e.g. saccharose (beet sugar) to the conditioning solution, the sticking together of the fruits during drying can be reduced further, beyond the effect of the calcium ions and the oil-in-water emulsion acting as a releasing oil emulsion. The sugar can be added to the calcium ion solution and/or the calcium ion/enzyme solution or the releasing oil emulsion/enzyme solution. The latter is more advantageous because washing off the sugar already applied in the first and/or second process step is then avoided. The sugar can, however, also be added to both solutions, the calcium ion/enzyme solution and the releasing oil emulsion/enzyme solution.

According to a preferred embodiment of the invention, a mixture of fructose and glucose is added as sugar, with the mixture ratio adjusted in such a way that it approximately corresponds to the natural sugar composition of the preconditioned fruit. In the case of strawberries, and also blueberries, the ratio of fructose to glucose is 1:1. If, in addition, a reprocessing and recirculation of the quantities of fruit juice being released by the fruits in the thawing/conditioning bath, described below, is used, the initially added sugar mixture is replaced in the course of the process by the natural sugar of the fruit already conditioned. Sugaring of the fruit with foreign sugar can thereby be avoided. In addition, this recirculation of the quantities of fruit juice is more ecological and economical than the alternative of simple disposal described above.

Regarding the releasing oil emulsion, it has been shown to be particularly advantageous if the oil emulsion is produced from an edible oil with a viscosity of 20-40, preferably 25-35 mPa·s. These types of oils are, for example, triglycerides of medium chain fatty acids with 8 to 10 C atoms in the fatty acid chain, the so-called MCT oils. Due to their good spreading behavior, even when they are used in an emulsion, these oils form a very thin oil film on the fruit pieces, which effectively presents sticking and clinging together of the individual fruit pieces during drying. In addition, these oils are completely taste-neutral, so that the very small amounts of oil remaining on the dried goods do not affect the taste in any way.

The regulations regarding food and drugs applicable for conditioning agents should also be followed in the selection of the emulsifier. It has been found that lecithins are particularly suitable, also from the viewpoint of their separation or release capability. Deoiled, enzymatically hydrolyzed soya lecithins have proven to be especially suitable.

In addition, sorbates and acetic acid esters have been successfully tested. Those skilled in the art will find further suitable candidates among the other non-ionic emulsifiers permissible according to the laws on food and drugs.

According to the invention, an amount of emulsifier of approximately 2.5 weight-% of the overall emulsion is used with approximately 5 weight-% oil content. The relative proportion of emulsifier in relation to oil is accordingly quite high which is also shown by the preferred range values recited in the sub-claims. The weight ratio of emulsifier to oil is advantageously approximately 1:10 to 1:1 and preferably around approximately 1:2. Even higher moieties of emulsifier are possible in principle, and have also been tested, but are impractical for reasons of cost.

Of the pectin esterases, mainly the typical products, obtained from microorganisms like Aspergillus Niger, such as ROHAPECT MPE (registered trademark) of Röhm Enzyme GmbH are suitable.

The preferred weight-% ranges for the addition of the agents indicated in the sub-claims are calculated on basis of the respective conditioning solution in which the agent is contained. Because the weight percentages of the respective agents contained in the respective aqueous solutions are relatively small, the weight percentage values practically hardly change when using two or more conditioning solutions instead of a single one. In the weight percent ranges indicated, gelling and hardening of the fruits which impairs the desired rehydration of the instant products can be prevented.

In a first example, the fruit is conditioned by subjecting the fruit to two baths of solutions. The first bath is a calcium chloride solution of the following composition:

30 g (0.30% by weight) calcium chloride (CaCl₂·2 H₂O)

9,970 g (99.70% by weight) water

10,000 g

The second bath includes the releasing oil emulsion, enzyme, and saccharose, and has the following composition:

1 g (0.01% by weight) pectin esterase (Rohapect MPE, trade name)

1000 g (10.00% by weight) saccharose (beet sugar)

250 g (2.50% by weight) lecithin (Emultop from Lucas Meyer, Hamburg, trade name)

500 g (5.00% by weight) MCT oil (Delios V from Grünau Illertissen, trade name)

8,249 g (82.49% by weight) water

10,000 g

The first bath is prepared by dissolving the calcium chloride in water that is heated so that the fruits or fruit pieces are heated to the optimum temperature for the activation of the pectin esterase enzyme present in the second bath. For the pectin esterase enzyme used, this temperature is approximately 35° C. The critical temperature for this enzyme of 45° C. should not be exceeded. This method of proceeding is also particularly suitable for the rapid thawing of deep frozen fruits.

The second bath is prepared by dissolving the lecithin in water prepared as described above. Subsequently, the oil is emulsified in this preparatory batch solution by means of a dispersion device. In a separate volume of water, the saccharose is dissolved. Finally, both portions of the solution, as well as the pectin esterase, are mixed intimately with one another. The solution in the second bath is then heated to the optimum temperature mentioned for the enzyme used with a maximum of 45° C., and, for example approximately at 35° C.

The fruits or fruit pieces are immersed in an immersion tub containing the solution of the first bath for a duration of at least approximately 1 minute, preferably approximately 5 minutes. The excess fluid is then allowed to drain in a suitable device, e.g. an oscillating or shaking chute. The fine particles of fruit, which encourage sticking together, are thereby also filtered off.

The short dwell time is possible because the adhering calcium chloride also continues to penetrate further into and act on the fruit pieces after the immersion in the bath. Thus, in an experiment, a good result was successfully achieved with only a two-minute reaction time in the calcium ion bath. The same applies for the pectin esterase. The minimum possible times also depend, however, on the type of fruit and the condition (size, cut, etc.) of the fruits to be handled. Of course, it is also possible to work with longer reaction times, if one is willing and able to accept them.

The fruits preconditioned in this way are immersed in the same manner in the second bath in a second process step and, after the excess fluid drips off, are fed to a dryer, whose operating parameters are adjusted to the respective fruits to the dried. The drying temperature selected is hereby sufficiently high to deactivate the pectin esterase enzyme used. In the present case, temperatures over approximately 85° C. are sufficient.

In the second bath, dwell times less than 1 minute are possible, because the adhering pectin esterase continues to be active in combination with the calcium chloride during the time necessary for charging the fruits or fruit pieces into the dryer and heating in the dryer to a temperature to deactivate the pectin esterase. The remaining conditioning agents (sucrose, oil, and emulsifier) act during the entire dwell time in the dryer.

The conditioning solutions can be applied in other ways, e.g. through spraying onto the fruits. However, it must be ensured that the active ingredients have a sufficient concentration and reaction time for the type of application, which depends both on the type of the fruits and their condition (fresh or frozen).

According to another embodiment of the invention, it is also possible to put all of the active ingredients in the releasing oil emulsion so that the conditioning can be performed in a single bath. This variant is advantageous due to the simplification of the process, when fruits are to be dried which tend to release only a small amount of juice and with which, therefor, the increase in volume of the oil emulsion to be disposed of is insignificant. This variant is also advantageous when the fruits are treated by spraying instead of immersing them into the bath solution and thereby the resulting amount of solution and/or emulsion to be disposed of is small.

In a second example a conditioning solution in a single bath can be used, such as a solution having the following composition:

30 g CaCl₂·2 H₂O

1 g Rohapect MPE

1,000 g Saccharose

250 g Emultop

500 g MCT oil Delios V

8,219 g water

10,000 g

In a third example, two baths having the following compositions can be used:

First bath

30 g CaCl₂·2 H₂O

1 g Rohapect MPE

1,000 g Saccharose

8,969 g water

10,000 g

Second bath

250 g Emultop

500 g MCT oil Delios V

9,250 g water

10,000 g

If e.g., frozen fruits, which tend to release only a small amount of water are to be conditioned, an initial water bath can also be provided upstream. As in the calcium chloride bath without the addition of pectin esterase, higher conditioning temperatures can then be used in this initial bath.

In the third example, the temperature of the second bath is not critical and can be adjusted, for example, between 20 and 25° C.

In addition to the compositions indicated, which have been shown to be especially advantageous for frozen strawberry pieces, a number of other compositions were tested in order to determine a preferred range. Acetic acid ester, as well as sorbates and sorbate mixtures such as Lamesorb 2567 and Lamesorb SMO 20 from Grünau Illertissen, were successfully used instead of the preferred lecithin as the emulsifier.

Significant progress was also achieved with the invention with banana slices, which are well-known to be difficult to condition. Citric acid and/or ascorbic acid were also added to the conditioning solution in this case.

The invention is also suitable in principle for all types of berries. If fruit pieces such as apple slices which are generally to be subjected to a bath conditioning in any case, the addition of the inventional conditioning additives for improvement of the consistency is recommended also in cases when the fruits could successfully be processed into instant products without the conditioning system according to the invention.

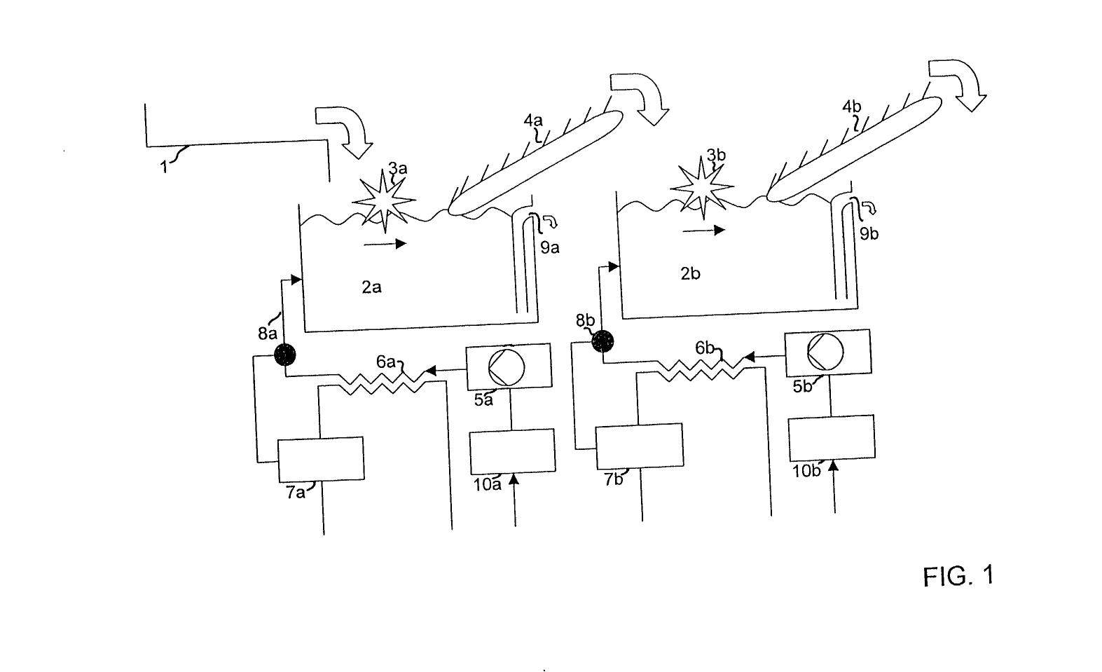

An embodiment of the device used in the inventional method especially suited for a throughput of large amounts of fruit and continuous conditioning corresponding to example 3 comprises, according to FIG. 1, an oscillating or shaking chute 1, an immersion bath 2a (1^{st} bath) as the heating bath and an immersion bath 2b (second bath). A paddle stirrer 3a, 3b is provided in each of the two baths. Sieve conveyor belts 4a, 4b serve for conveyance between the baths and to a dryer stage for further processing. Furthermore, pumps 5a, 5b, heat exchangers 6a, 6b, temperature regulators 7a, 7b, temperature sensors 8a, 8b, overflows 9a, 9b, and ingredient dosers 10a, 10b are provided for the respective immersion baths 2a, 2b, which are, in the present embodiment tubs. The paddle stirrer 3b promotes dispersion and serves to prevent flocculation. The pumps 5a and 5b serve for charging the conditioning solutions and are appropriately adjusted for the respective use.

The fruits or fruit pieces reach the heating bath 2a via the oscillating chute 1, on which they are freed from fine particles. The fruits are heated in this bath 2a containing the calcium chloride solution to a temperature optimum for the effectiveness of the pectin esterase of e.g. approximately 35° C. The bath is agitated for improvement of heat transfer by means of the paddle stirrer 3a and the fruits are simultaneously moved in the direction of the sieve conveyor belt 4a which removes the fruits from the immersion bath 2a and transfers them into the immersion bath 2b with the pectin esterase solution.

Small amounts of juice released from the fruits into the solution of the immersion bath 2a cause an increase in volume of the solution, which is discharged via the overflow 9a projecting into the lower region of the tub and disposed of. Simultaneously, fresh calcium chloride solution, which is heated to the temperature required by means of the temperature regulator 7a and the heat exchanger 6a, is dosed into the immersion bath 2a via the doser 10a.

In a plurality of experiments the temperature was varied over a wide range of possible temperatures between 5° c. and 45° C. An advantageous temperature range is between 5 and 15° C. The fruits, which are, also at these rather low temperatures, colder than the solution, are hereby heated up after having been charged into the solution. The fruits are preferably preheated to an elevated temperature before being charged into solution in order to restrict the subsequent heating to a minimum. The heating can also be caused by introducing direct steam into the bath 2a and/or through high frequency heating.

The fruits supplied to the immersion bath 2a are moved slowly enough through the bath, by means of the paddle stirrer 3a, and so that the preferable dwell time, according to the present embodiment of the invention, of approximately 5 minutes in this bath is achieved. In the immersion bath 2b, the enzyme solution causes a demethoxylation of the pectin and, in combination with the calcium ions which have diffused into the fruits, allows even better juice fixing and stabilization in the fruits than is achieved through the calcium ion bath alone.

An excess of fluid carried in with the fruits which does not drip off on the sieve conveyor belt 4a causes an increase in fluid in the immersion bath 2b, whose excess fluid is discharged via the overflow 9b. In order to prevent depletion of the conditioning agents, fresh emulsion solution with pectin esterase and saccharose, which was previously heated by means of the temperature sensor 8b, the temperature regulator 7b, and heat exchanger 6b to the preferred temperature of approximately 35° C., is fed in simultaneously by means of doser 10b.

The maximum permissible temperature in the bath containing pectin esterase depends on the respective pectin esterase preparation used. In the present case, the critical upper limit of the temperature is 45° C. Lower temperatures, such as room temperature, are also entirely usable. Finally, temperatures significantly below room temperature have also successfully used. As already outlined above, this is possible because the pectinesterase adhering to the fruits or fruit pieces is still active when transferring the conditioned fruits or fruit pieces to a predrying device and during subsequent predrying step therein before the predrying temperature reaches the relatively high temperatures at which the pectinesterase is deactivated.

After the sieve conveyor belt 4b has removed the fruits from bath 2b and the fruits have sufficiently drained on the belt, they are transferred into the dryer, not shown; the air belt dryer of a multistage drying facility in the present embodiment.

The ratio of the amount of fruit relative to the conditioning solution was adjusted in the outlined device at approximately 1:1, i.e., e.g., 100 liters of conditioning solution for 100 kg of cut strawberries.

In a further tested embodiment of the device according to the invention, the fruits and/or fruit pieces are first poured into basket-like, bowl-shaped containers and these are sequentially immersed, e.g., by means of a pendulum or pivoted bucket conveyor (also called bucket elevator), into the various baths. In this embodiment, the paddle stirrers 3a, 3b and the conveyor belts 4a, 4b are not used.

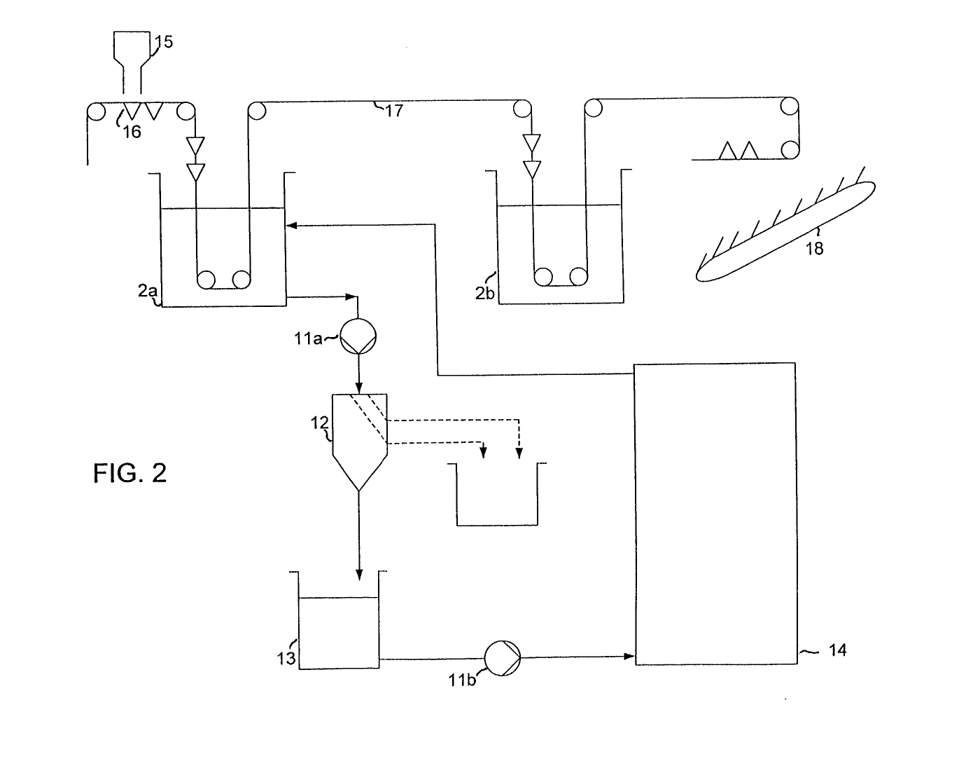

FIG. 2 shows a device modified in comparison to the device of FIG. 1. The mode of operation of this modified device will be described with reference to the pre-conditioning of frozen strawberry pieces. The pre-conditioning of the fruits and/or fruit pieces is preferably performed, also when using a pivoted bucket conveyor, in two separate baths 2a, 2b, because the immersion bath 2a is continuously diluted by the juice of the thawed fruits. The dilution is significant in the case of strawberries or also, e.g., blackberries. Due to the dilution, the concentrations of the bath additives decrease due to the water released by the fruits, while the portion of fine particles and pectin jelly in the bath increases. For berries, which release a significant amount of juice upon being thawed, reprocessing and recirculation of the diluted immersion bath solution is therefore ecologically advantageous and economical.

An embodiment of the device to be used in the method according to the invention for reprocessing of the immersion bath 2a is shown in FIG. 2. For clarity purpose, the device components 5, 6, 7, 8, and 10 for the bath supply are not shown. The conditioning solution system can, e.g., have the composition according to example 3.

The device comprises two circulating pumps 11 a, 11b, an oscillating screen 12, and a drip basin 13 and sieving out the fine particles for the purpose of collecting the fruit juice. The quantity of fluid discharged and removed via the overflow 9a in FIG. 1 from the first bath 2a, which contains fruit sugar, is supplied to the oscillating screen 12 by means of the pump 11a. The solids filtered out are carried away in a further container, as is indicated by the dashed arrows. The sieved juice is fed into an evaporator 14 from the juice drip basin 13 by means of the pump 11b. The sugar solution is heated there and a part of the water steam is thereby removed from it.

In a device implemented with, e.g., 2300 kg/h of product feed, approximately 15 m³/h of the first immersion bath is circulated and sieved for reuse by means of an oscillating screen device 12 (from the Company Bellmer GmbH, 75223 Niefern-Öschelbrunn, Germany). The evaporator 14 (from the Company Entropie GmbH, 85135 Erding, Germany) is designed such that, at this throughput of 15 m³/h, it heats the sugar solution supplied by a temperature of 15° C. and thereby removes 450 kg/h water steam from a partial amount of the solution water steam. In this way, the solution is concentrated and, at the same time, the heat required for thawing the fruits is also continuously supplied to the bath 2a.

After cutting, the frozen strawberries are poured by means of a filling hopper 15 into the buckets 16 of a pivoted bucket conveyor 17 (from the Company Humbert & Pol, 49326 Melle, Germany). The buckets being provided with screen-like walls are each filled with approximately 5 kg of strawberry cubes at a clock rate of approximately 8 s in the following manner: A bucket is moved under the filling hopper, whereby the two flaps of the bucket are opened, the flap in the filling hopper releases a batch of approximately 5 kg of strawberry cubes which fall into the bucket, and the bucket is reclosed and moved to the next position.

The chain of buckets filled in this way is cyclically moved with a timing corresponding to the operating parameters selected, through the thawing basin 2a, and the contents are thereby heated to approximately 20° C. After a draining time of, e.g., one minute, they are immersed in the conditioning bath 2b. After leaving the conditioning bath, the buckets can drain over the bath. Subsequently, the buckets are turned upside down by reversing the direction of the chain (as shown on the right hand side of FIG. 2) and the contents are emptied one at a time onto an oscillating chute 18, provided transversely to the direction of conveyance, by opening the bucket flaps. This chute transports and distributes the thawed and preconditioned strawberry cubes onto the conveyor belt of a predryer (not shown). The opened buckets move through a cleaning station back to the feeding station.

In this device, a number of altered conditioning baths, such as in a fourth example disclosed below, were tested. A conditioning system, such as in the fourth example disclosed below, in which a sugar mixture similar to a fruit sugar was added to both baths was successfully used for frozen strawberry cubes.

In the fourth example two baths with the following composition is used. The first bath in the conditioning basin 2a includes:

0.3% by weight of CaCl₂·H₂O and

20% by weight of (10% by weight of fructose and 10% by weight of glucose),

Temperature approximately 20° C. and conditioning time 2 minutes

The second bath in the conditioning basin 2b includes:

5% by weight of MCT oil Delios V

2.5% by weight of lecithin-emulsifier Emultop

20% by weight of sugar (10% by weight of fructose and 10% by weight of glucose), and

0.01% by weight of pectin esterase Rohapect MPE.

Temperature approximately 20° C. and conditioning time 1 minute

In addition to frozen blueberries, a variety of other fruits and/or fruit pieces could advantageously be preconditioned in this way. Depending on the acidity and the osmotic conditions specific to the fruit, significantly higher sugar content than for the strawberries, of up to over 50% by weight, have also been used. For fruits which have little tendency to release juice and to stick together, such as cultivated blackberries and blueberries, outstanding pretreatment results can also be achieved with frozen fruits, even with only the first bath, so that in this case the fruits are merely subjected to the calcium ions and sugar, but not to conditioning with pectin esterase and the emulsion.

A device for concentrating discharged conditioning solution and recirculating the concentrated solution to the second bath can likewise be provided for bath 2b with overflow 9b shown in FIG. 1. Finally, it should be noted again here that the conditioning steps according to the invention can also be implemented with three or more baths. Thus, for fruits which tend to release less juice, a simple thawing bath (therefore a third bath in comparison to examples 3 and 4), to which sugar can be added, can be placed upstream as an initial bath. The pectin esterase can be contained in an additional third or fourth bath, respectively, between a bath with calcium ions and a bath with the oil-in-water emulsion. Finally, the active ingredients, especially the sugar and the pectin esterase, can be contained in several of the baths.

We claim:

1. A Method for conditioning fruits for subsequent drying for production of an instant product, said method comprising:
subjecting the fruits to conditioning in a conditioning solution including calcium ions, pectin esterase, and an oil-in-water emulsion, to which oil-in-water-emulsion an emulsifier is added in an amount of more than 1% by weight.

2. Method according to claim 1, wherein some of the fruits to be conditioned are selected from the group consisting of whole fruits, fruit pieces, whole fresh fruits, fresh fruit pieces, whole frozen fruits and frozen fruit pieces.

3. Method according to claim 1, wherein the fruits are conditioned in a single solution containing calcium ions, pectin esterase and said oil-in-water emulsion.

4. Method according to claim 1, wherein the fruits are subjected first to conditioning with a calcium ion solution and subsequently to conditioning with pectin esterase solution and the oil-in-water emulsion by immersing the fruits in the respective solutions.

5. Method according to claim 1, wherein the conditioning with calcium ions and pectin esterase is performed at temperatures between 5° C. and 45° C.

6. Method according to claim 1, wherein, in addition, sugar is used for conditioning.

7. Method according to claim 6, wherein the sugar is used in form of a sugar mixture which is adapted to the natural ratio of fructose to glucose in the fruit sugar of the fruit sort conditioned.

8. Method according to claim 1, wherein the sugar is added in one or a plurality of conditioning steps.

9. Method according to claim 1, wherein a part of the conditioning solution which shows an increase in volume due to fruit juice being released by the fruits, is processed such that water is removed therefrom and that it is subsequently fed back into the conditioning solution.

10. Method according to claim 1, wherein the conditioning steps are performed in one, two, three, or more baths, with a thawing bath, with or without added sugar, which is provided upstream said baths.

11. Method according to claim 10, wherein the pectin esterase is added in a separate bath and/or in one or more of the baths containing the calcium ions and the oil-in-water emulsion.

12. Method according to claim 1, wherein the following amounts by weight % are in the respective conditioning solution:
Calcium chloride solution: 0.01 to 1% by weight
Pectin esterase solution: 0.003 to 0.03% by weight
Oil-in-water emulsion:

| | |
|---|---|
| Emulsifier | 1 to 7% by weight |
| Oil | 2 to 20% by weight |

13. Method according to claim 1, wherein the following amounts by weight % are in the respective conditioning solution:
Calcium chloride solution: approximately 0.3% by weight
Pectin esterase solution: approximately 0.01% by weight
Oil-in-water emulsion:

| | |
|---|---|
| Emulsifier | 2 to 3% by weight |
| Oil | 4 to 6% by weight. |

14. Method according to claim 1, wherein the emulsifier is a lecithin.

15. Method according to claim 14, wherein the emulsifier is an enzymatically hydrolyzed soya lecithin.

16. Method according to claim 1, wherein the oil-in-water emulsion contains an edible oil with a viscosity of 25 to 35 mPa·s.

17. Method according to claim 1, wherein the oil-in-water emulsion contains a triglyceride of medium chain fatty acids.

18. Method according to claim 1, wherein sugar is added, depending on the fruit to be conditioned, in an amount of up to 50% by weight of the conditioning solution.

19. Method according to claim 1, wherein calcium chloride is provided as carrier for the calcium ions in the conditioning solution.

20. Method according to claim 1, wherein part of the conditioning solution which exhibits an increase in volume due to the release of fruit juice is removed from the solution, is concentrated by evaporation of water and is recirculated in the conditioning solution after having been concentrated.

21. Method according to claim 1, wherein the fruits are charged and discharged into and from the conditioning solutions by means of a pivoted bucket conveyor.

22. A method of conditioning fruit for subsequent drying for production of an instant product, wherein the fruit is frozen which has little tendency to release juice and to stick together, said method comprising:
subjecting the fruit to conditioning in a conditioning solution including calcium ions and sugar, wherein at least some of the sugar is in the form of a sugar mixture which is adjusted to the natural ratio of fructose to glucose in the fruit sugar of the fruit.

23. A method of conditioning fruit for subsequent drying for production of an instant product, wherein the fruit is frozen, said method comprising:
subjecting the fruit to conditioning in a conditioning solution including calcium ions and sugar;
accumulating fruit juice released from the fruit in the solution;
removing some of the fruit juice from the solution; and wherein part of the conditioning solution which exhibits an increase in volume due to the release of fruit juice is removed from the solution, is concentrated and is recirculated in the conditioning solution after having been concentrated.
